(19) United States
(12) Patent Application Publication
(10) Pub. No.: US 2016/0012520 A1
(43) Pub. Date: Jan. 14, 2016

(54) System And Method Of Administering Auctions

(71) Applicant: AuctionsByCellular, Westmont, IL (US)

(72) Inventor: Richard Aquino, Libertyville, IL (US)

(21) Appl. No.: 14/327,768

(22) Filed: Jul. 10, 2014

(51) Int. Cl. G06Q 30/08; H04W 4/02

(52) U.S. Cl. CPC G06Q 30/08; H04W 4/028

(57) ABSTRACT

A system and method of administering auctions having a plurality of steps and components to determine the location of an event, to determine boundaries for the location and to determine as to whether a received actual bid came from a bidder within the boundaries. Auctions, it will be understood, include but are not limited to silent auction type auctions, as well as sales of goods using traditional sales of goods transactions.

### CROSS-REFERENCE TO RELATED APPLICATION

N/A

### BACKGROUND OF THE DISCLOSURE

1. Field of the Disclosure

The disclosure relates in general to auction administration, and more particularly, to a system and method of administering auctions. The disclosure is exceedingly useful in situations wherein a silent auction at an event is administered on-line through interaction between the smartphones or tablets (collectively, smartphones) and the auction servers. In such instances, it is often desirable to limit the actual bidders and actual bidding to the participants at the event. It will be understood that auctions may include the direct or indirect sales of items, and not limited to traditional silent auctions or the like.

2. Background Art

The conducting of, for example, silent auctions and the like is well known in the art. In many instances, a silent auction is utilized at an event to raise money and to raise interest in the event. Many times such silent auctions are operated for the benefit of a charity or charities. In the past, a bidder would manually write a proposed bid on a sheet of paper at, for example, a bidding table or the like. Other bidders could also write a proposed bid on the sheet of paper in sequential order. The bidder with the highest bid when the auction closes becomes the winner of the item. As such, it is often necessary to return to the sheet of paper to determine the highest bid.

Due to advances in technology, the sheet of paper has been replaced by an on-line, or computing device driven, operation of silent auctions. In such instances, bidding is done over a website (or through a dedicated application) that is accessible from a computing device. Often such a computing device comprises a smartphone. The user interacts with the website to enter a bid for the item. As the actual bidding process is virtual, the system can provide updates to the user on a real time or apparently real time basis. That is, if the user has been outbid, an email or text message or notification on the website, or other alert can be provided to the user indicating that the user has been outbid. In addition, the user can be alerted as to when the auction is ending, or can watch bidding on an item wherein the user has not bid, but may be desirous of bidding.

Problematically, it has been difficult to limit the participants of such an auction to individuals and bidders that are present at an event. It has not been difficult for hackers that are not attending the events to bid on items (with no intent to purchase). It has also been cumbersome to provide specific log in details to limit participation to only those that are attending the event.

### SUMMARY OF THE DISCLOSURE

The disclosure is directed, in one aspect, to one or more computer storage media comprising computer-executable instructions for administering an auction. The computer-executable instructions when executed by a computing device perform steps comprising: determining a location of an event; determining a boundary of the location; setting the boundary for purposes of accepting a bid; receiving an actual bid for an item at the auction from a user; receiving data corresponding to a user location; and determining whether the user that made the actual bid is within the boundary of the location.

In some examples, further steps are accomplished, namely the steps of accepting the actual bid if the user is within the boundary; and rejecting the actual bid if the user is not within the boundary.

In some examples, the step of determining a location of an event comprises the step of: determining a plurality of coordinates that correspond to the location; and calculating a plurality of coordinates that define the boundary.

In some examples, the step of determining a plurality of coordinates comprises latitude and longitude.

In some examples, the step of receiving an actual bid comprises the step of receiving an actual bid from a user through a smartphone or tablet.

In some examples, the auction comprises a silent auction type of auction. In other examples, the auction comprises a traditional sales of goods type of exchange.

In another aspect of the disclosure, the disclosure is directed to a method of administering an auction that comprises the steps of determining a location of an event; determining a boundary of the location; setting the boundary for purposes of accepting a bid; receiving an actual bid for an item at the auction from a user; receiving data corresponding to a user location; and determining whether the user that made the actual bid is within the boundary of the location.

In some examples, the method further comprises the steps of: accepting the actual bid if the user is within the boundary; and rejecting the actual bid if the user is not within the boundary.

In some examples, the step of determining a location of an event comprises the step of: determining a plurality of coordinates that correspond to the location; and calculating a plurality of coordinates that define the boundary.

In some examples, the step of determining a plurality of coordinates comprises latitude and longitude.

In some examples, the step of receiving an actual bid comprises the step of receiving an actual bid from a user through a smartphone or tablet.

In some examples, the auction comprises a silent auction type of auction. In other examples, the auction comprises a traditional sales of goods type of exchange.

In yet another aspect of the disclosure, the disclosure is directed to an auction administration system comprising a general-purpose computing device that is associated with a user and a system for determining the validity of an actual bid. The system for determining the validity of an actual bid includes a determination component for determining a location of an event; a determination component for determining a boundary of the location; a setting component for setting the boundary for purposes of accepting a bid; a receiving component for receiving an actual bid for an item at the auction from a user; a receiving component for receiving data corresponding to a user location; and a determining component determining whether the user that made the actual bid is within the boundary of the location.

In some examples, the system further comprises an accepting component for accepting the actual bid if the user is within the boundary; and a rejecting component for rejecting the actual bid if the user is not within the boundary.

In some examples, the general-purpose computing device comprises a smartphone or a tablet.

In some examples, the auction comprises a silent auction type of auction. In other examples, the auction comprises a traditional sales of goods type of exchange.

### BRIEF DESCRIPTION OF THE DRAWINGS

The disclosure will now be described with reference to the drawings wherein:

FIG. 1 of the drawings is a schematic representation of the system of the present disclosure;

FIG. 2 of the drawings is a schematic representation of a general-purpose computing device; and

FIG. 3 of the drawings is a flow chart of the operation of the system of the present disclosure.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

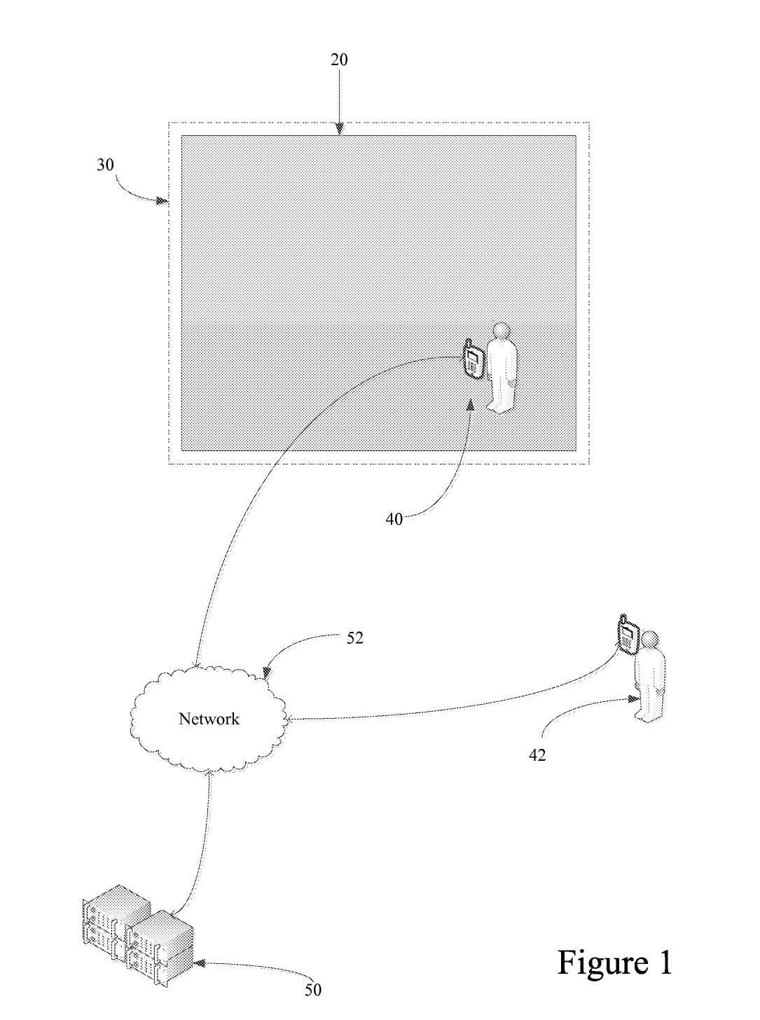

Referring now to the drawings and in particular to FIG. 1, a system is disclosed for the operation of an auction. As has been the case, many events have a silent auction that is utilized to raise money for, for example, charities. In the past, each item up for silent auction would be accompanied by a sheet of paper or other ledger. A bidder would physically walk to the sheet and write a bid for the item. At any time, a subsequent bidder can walk to the sheet and write a higher bid for the item. This continues until the closing of the silent auction. It is generally necessary to revisit the sheet of paper to see the level of bidding, and if one has bid, the position or veracity of the bid (i.e., whether or not the bidder has been outbid). Again, it will be understood that the term “auction” includes traditional bidding auctions, silent auctions, the purchase of goods in a traditional sales format, a “buy it now” type of sales format, a sale in a “best offer” type of sales format.

Certain advances in technology have led to on-line operation of silent auctions. That is, each item can be physically seen at a table or other location (this may not be the case in many auctions), but the bidding is done over a website (or through a dedicated application) that is accessible from a general-purpose computing device (which will be defined hereinbelow). Often such a computing device comprises a smartphone or a tablet. The user interacts with the website to enter a bid for the item. As the actual bidding process is virtual, the system can provide updates to the user on a real time or apparently real time basis. That is, if the user has been outbid, an email or text message or notification on the website, or other alert, can be provided to the user indicating that the user has been outbid. In addition, the user can be alerted as to when the auction is ending, or can watch bidding on an item wherein the user has not bid, but may be desirous of bidding.

One feature of such auctions is that they are typically done by way of an on-site or location based event. In fact, often, one of the draws for an event is the silent auction and the items that are being auctioned at the event. As such, it is desirable to limit the participants of the silent auction to attendees. In the past, as physical writing on sheets of paper associated with an auction item, or a ledger, required a bidder to generally be present at the event (or to be represented by a proxy), this has not been problematic. However, with such advances in technology, anyone with access to the website, application or other bidding manner of operation, has access to bid on items at a silent auction. This can be problematic for two reasons. First, hackers can bid up items and then not show up to pay for the item (or to otherwise disrupt the auction process). Second, such a possibility reduces the value of attending the event.

As such, the system of the present disclosure is configured to provide a gate keeper to determine as to whether a potential bidder is qualified to enter the desired bid on an item. One such system is shown in FIG. 1. A location 20 is shown schematically through a generally square area. The location may represent a room, a building, a region outdoors, multiple buildings, an outdoor venue, etc. Indeed, there is no limit as to where and what the location may comprise. A boundary 30 is shown schematically as a dashed line that generally conforms to the boundary of the location. The boundary is the area within which the system has determined an acceptable bidder must be located. As will be explained below, the boundary can be determined through coordinates that can be determined through different means, including but not limited to a global positioning system (GPS) and the like. Individual 40 is shown schematically as holding a general-purpose computing device in the form of a smartphone having location tracking (i.e., GPS enabled). Individual 42 is shown schematically as holding a general-purpose computing device in the form of a smartphone having location tracking. The difference between the two individuals is that individual 40 is within the boundary of the location, whereas individual 42 is outside of the boundary of the location. Each smartphone of each individual is capable of communicating with the remote server 50 through the Internet or other communication network 52. The server 50 is configured to coordinate the bidding for different items and to essentially handle the task of the bidding and the auction process. It will be understood that the server 50 is another general-purpose computing device. The server 50 may be simultaneously handling a number of different auctions that are occurring at a number of different locations. As will be explained below, the system is configured to allow the individual 40 to register a bid for an auction item at the bidding location (that is, if the individual 40 meets the other bidding criteria, including, but not limited to, financial ability, bidding eligibility, etc.) while precluding individual 42 from bidding on an auction item.

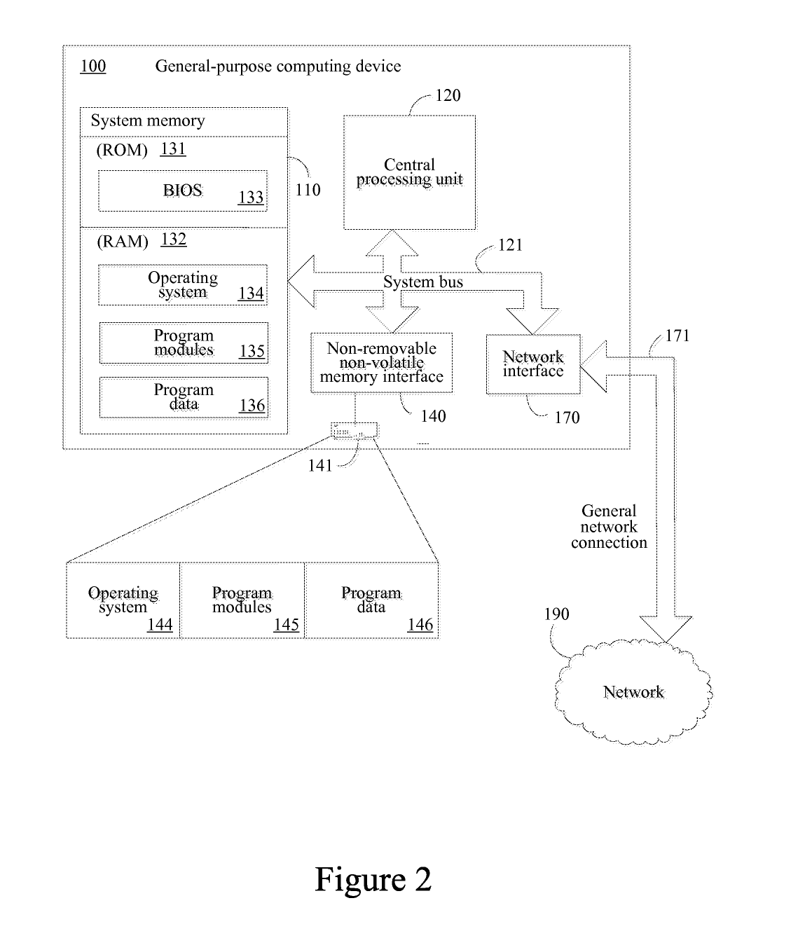

With reference to FIG. 2, an exemplary general-purpose computing device is illustrated in the form of the exemplary general-purpose computing device 100. The exemplary general-purpose computing device 100 can include, but is not limited to, one or more central processing units (CPUs) 120, a system memory 130 and a system bus 121 that couples various system components including the system memory to the processing unit 120. The system bus 121 may be any of several types of bus structures including a memory bus or memory controller, a peripheral bus, and a local bus using any of a variety of bus architectures. Depending on the specific physical implementation, one or more of the CPUs 120, the system memory 130 and other components of the general-purpose computing device 100 can be physically co-located, such as on a single chip. In such a case, some or all of the system bus 121 can be nothing more than communicational pathways within a single chip structure and its illustration in FIG. 2 can be nothing more than notational convenience for the purpose of illustration.

The general-purpose computing device 100 also typically includes computer readable media, which can include any available media that can be accessed by computing device 100. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 100. Computer storage media does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 100 may operate in a networked environment via logical connections to one or more remote computers. The logical connection depicted in FIG. 2 is a general network connection 171 to the network 190, which can be a local area network (LAN), a wide area network (WAN) such as the Internet, or other networks. The computing device 100 is connected to the general network connection 171 through a network interface or adapter 170 that is, in turn, connected to the system bus 121. In a networked environment, program modules depicted relative to the general-purpose computing device 100, or portions or peripherals thereof, may be stored in the memory of one or more other computing devices that are communicatively coupled to the general-purpose computing device 100 through the general network connection 171. It will be appreciated that the network connections shown are exemplary and other means of establishing a communications link between computing devices may be used. It will also be understood that the general-purpose computing device may include location tracking information, such as current location, which can be provided through various means including wifi, GPS, among others.

The general-purpose computing device 100 may also include other removable/non-removable, volatile/nonvolatile computer storage media. By way of example only, FIG. 2 illustrates a hard disk drive 141 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM 132, solid state ROM 131, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the general-purpose computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

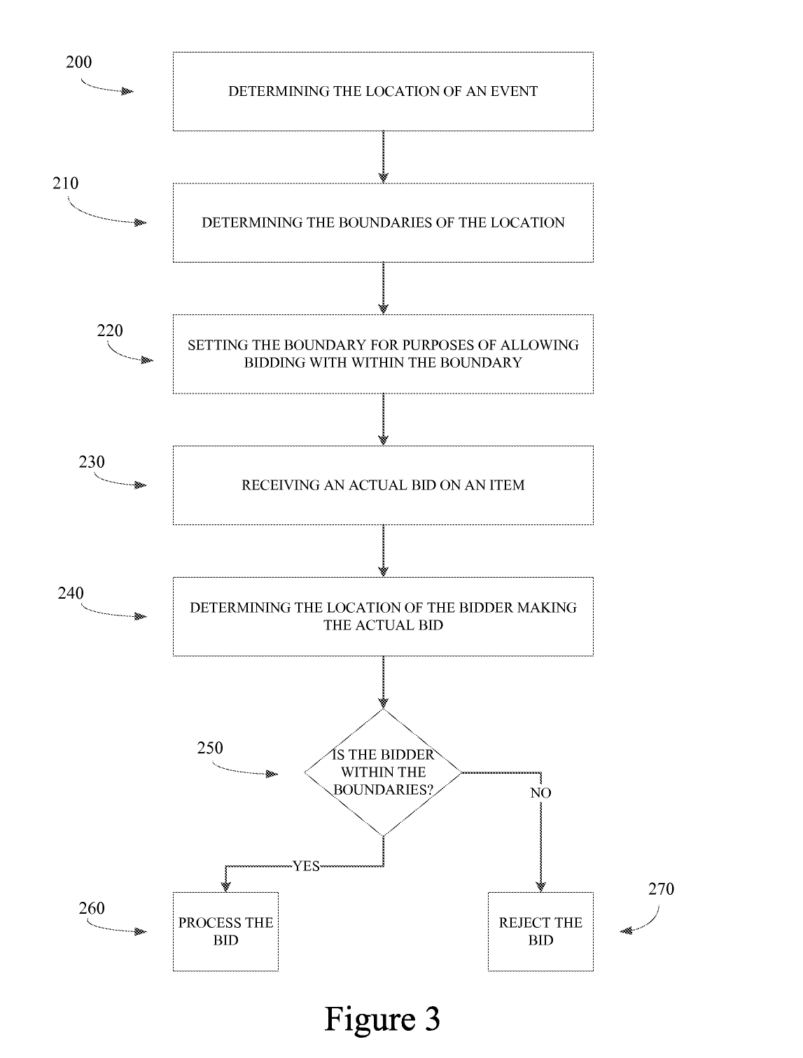

The operation of the system will be shown with reference to FIG. 3. In particular, the system first determines the location of the event at step 200. This information can be provided to the system in a number of manners, including map location, address, among others. It will also be understood that the GPS coordinates of the location may be provided.

Once the location has been determined, at step 210, the system determines the boundaries of the location. The boundaries of the location can be determined using maps and automated to match the boundaries of a building or venue. In other embodiments, the boundaries of the location may be manually provided based on, for example, location coordinates that can be obtained through maps, or through visiting the location. In still other embodiments, a radius is set around a particular set of coordinates, such as the center of the auction table, the center of the store, or venue.

Once the boundaries have been determined, the system finalizes and sets the boundaries for purposes of bidding at step 220. That is, the coordinates of the boundary are reviewed and provided to the system forming the boundaries of bidding for the location. The coordinates may comprise latitude and longitude coordinates, among other coordinates. It will be understood that the coordinates may comprise a regions of different sizes, including but not limited to a few feet to a few yards, to a few miles to a number of miles.

Once the auction has started, different users connect to the system through, for example, their smartphone. Eventually, a bid is received for an item in the auction at step 230. Once the bid is received, other information is likewise transmitted to the system. Such information may include an identification of the individual (which may be accomplished through a username/password login procedure, a unique code, a tie to the phone number associated with the smartphone, among others) as well as the location of the smartphone, and in turn, the individual. At step 240, the system determines the location of the bidder.

At step 250, the system determines if the user making the bid is within the boundaries that have been set for purposes of the bidding. If it is determined that the user is within the boundary that has been set, the bid is processed at step 260. If on the other hand the user is not within the boundary that has been set, the bid is rejected at step 270. The user may receive a message by way of a text, an email or other communication that the bid has been rejected, and this may include the reason for the rejection (i.e., that the user has gone beyond the boundary set for eligible bidders). For example, if the user stepped out of the boundary, temporarily, the user can return to the location within the boundary and retry to make a bid.

In an alternative system, the system can receive information from the user at predetermined intervals, or in another manner track the location of the user over a period of time. As such, the system could allow a bid if the user was within the boundary of the location over a relevant (and system determined) time period, but that the user had gone outside of the boundary at the time of the bid. In addition, other variations are contemplated as well.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. One or more computer storage media comprising computer-executable instructions for administering an auction, the computer-executable instructions when executed by a computing device performing steps comprising:
determining a location of an event;
determining a boundary of the location;
setting the boundary for purposes of accepting a bid;
receiving an actual bid for an item at the auction from a user;
receiving data corresponding to a user location; and
determining whether the user that made the actual bid is within the boundary of the location.

2. The computer storage media of claim 1 further comprising the steps of:
accepting the actual bid if the user is within the boundary; and
rejecting the actual bid if the user is not within the boundary.

3. The computer storage media of claim 1 wherein the step of determining a location of an event comprises the step of:
determining a plurality of coordinates that correspond to the location; and
calculating a plurality of coordinates that define the boundary.

4. The computer storage media of claim 3 wherein the step of determining a plurality of coordinates comprises latitude and longitude.

5. The computer storage media of claim 1 wherein the step of receiving an actual bid comprises the step of receiving an actual bid from a user through a smartphone or tablet.

6. The method of claim 1 wherein the auction comprises a silent auction type of auction.

7. The method of claim 1 wherein the auction comprises a traditional sales of goods type of exchange.

8. A method of administering an auction comprising the steps of:
determining a location of an event;
determining a boundary of the location;
setting the boundary for purposes of accepting a bid;
receiving an actual bid for an item at the auction from a user;
receiving data corresponding to a user location; and
determining whether the user that made the actual bid is within the boundary of the location.

9. The method of claim 8 further comprising the steps of:
accepting the actual bid if the user is within the boundary; and
rejecting the actual bid if the user is not within the boundary.

10. The method of claim 8 wherein the step of determining a location of an event comprises the step of:
determining a plurality of coordinates that correspond to the location; and
calculating a plurality of coordinates that define the boundary.

11. The method of claim 10 wherein the step of determining a plurality of coordinates comprises latitude and longitude.

12. The method of claim 8 wherein the step of receiving an actual bid comprises the step of receiving an actual bid from a user through a smartphone or a tablet.

13. The method of claim 8 wherein the auction comprises a silent auction type of auction.

14. The method of claim 8 wherein the auction comprises a traditional sales of goods type of exchange.

15. An auction administration system comprising:
a general-purpose computing device associated with a user;
a system for determining the validity of an actual bid including:
a determination component for determining a location of an event;
a determination component for determining a boundary of the location;
a setting component for setting the boundary for purposes of accepting a bid;
a receiving component for receiving an actual bid for an item at the auction from a user;
a receiving component for receiving data corresponding to a user location; and
a determining component determining whether the user that made the actual bid is within the boundary of the location.

16. The system of claim 15 further comprising:
an accepting component for accepting the actual bid if the user is within the boundary; and
a rejecting component for rejecting the actual bid if the user is not within the boundary.

17. The system of claim 15 wherein the general-purpose computing device comprises a smartphone or a tablet.

18. The method of claim 15 wherein the auction comprises a silent auction type of auction.

19. The method of claim 15 wherein the auction comprises a traditional sales of goods type of exchange.
